(19) United States
(12) Patent Application Publication
(10) Pub. No.: US 2005/0262367 A1
(43) Pub. Date: Nov. 24, 2005

(54) Power-saving system for a computer peripheral

(76) Inventor: Po-Sheng Shih, Hsinchu City (TW)

Correspondence Address: RABIN & Berdo, PC, 1101 14TH STREET, NW, SUITE 500, WASHINGTON, DC, 20005, US

(21) Appl. No.: 11/025,012

(22) Filed: Dec. 30, 2004

(30) Foreign Application Priority Data
May 24, 2004 (TW) 93114666

(51) Int. Cl. G06F 1/32

(52) U.S. Cl. 713/323

(57) ABSTRACT

A power-saving system for a computer peripheral includes a computer, a power switch controller and a computer peripheral. The power switch controller is electrically connected to the computer and the computer peripheral. The power witch controller is for detecting an operation mode of the computer, receiving a power and transmitting the power to the computer peripheral. When the power switch controller detects that the computer is in an idle mode, the power switch controller cuts off the power to the computer peripheral.

This application claims the benefit of Taiwan application Serial No. 93114666, filed May 24, 2004, the subject matter of which is incorporated herein by reference.

### BACKGROUND OF THE INVENTION

1. Field of the Invention

The invention relates in general to a power-saving system for a computer peripheral, and more particularly to a power-saving control device for cutting off a power of a computer peripheral when a computer, electrically connected to the computer peripheral, enters an idle mode.

2. Description of the Related Art

With the newly and rapidly developed technologies, computers and computer peripherals have become quite indispensable in the modern daily life. The computer peripherals include devices, such as scanners, printers, fax machines and MFPs (Multi-Function Peripherals). However, in a standby mode the consumed power of the computer peripherals currently in use is typically greater than 1 watt, or even a power adaptor itself consumes a power greater than 1 watt. As a result, the computer peripherals not only waste energy, but also, due to the higher energy consumption, generate an electromagnetic wave or the so-called electromagnetic interference (EMI), harmful to human beings.

Recently, the power-saving technology of the computer peripherals has been advancing. For example, the Taiwan Patent Publication Number 502154 discloses a power-saving device and a method for a computer peripheral apparatus, in which whether the computer monitor enters the power-saving mode or the enabled mode is determined according to a power-saving command outputted from the computer host to the computer monitor, and the power-saving command outputted from the computer host is the horizontal and vertical sync signals outputted from the computer host to the computer monitor. However, unlike the computer monitor, not all of the computer peripherals can continuously receive the power-saving command outputted from the computer. For example, the computer sends signals to a scanner or a MFP only when the scanner or MFP is to be used. In addition, the current computer peripherals themselves do not have the function of actively detecting the state of the computer, so the computer peripherals cannot automatically switch themselves to a power-saving mode when the computer is in the idle state.

With the international consciousness of the environment protection issues and the requirements by the related laws and regulations, particularly the regulations regarding energy-efficient use of power devices in the United States federal facilities, the standby power of computer peripherals has to be smaller than 1 watt. However, the power-saving device disclosed in the Taiwan Patent Publication Number 502154still consumes a voltage of 5 volts in the power-saving mode in order to recover to a normal state from the power-saving mode. In other words, the current computer peripherals and the power-saving device disclosed in the Taiwan Patent Publication Number 502154 does not meet the newest energy efficiency regulations.

### SUMMARY OF THE INVENTION

It is therefore an object of the invention to provide a power-saving system for a computer peripheral. The power-saving system has a power switch controller capable of cutting off the power to a computer peripheral when it detects that a computer is in an idle mode. Thus, it is possible to reduce the energy usage and the electromagnetic wave intensity, and to meet the newest energy efficiency regulations for electrical devices in the United States.

The invention achieves the above-identified object by providing a power-saving system including a computer, a power switch controller and a computer peripheral. The power switch controller is electrically connected to the computer and the computer peripheral. The power switch controller is for detecting an operation mode of the computer, receiving a power and transmitting the power to the computer peripheral. When the power switch controller detects that the computer is in an idle mode, the power switch controller cuts off the power to the computer peripheral.

The invention also achieves the above-identified object by providing a power-saving control device to be electrically connected to a computer and a computer peripheral. The power-saving control device includes a power switch controller for detecting an operation mode of the computer, receiving a power and transmitting the power to the computer peripheral. When the power switch controller detects that the computer is in an idle mode, the power switch controller cuts off the power to the computer peripheral.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram showing a power-saving system for a computer peripheral according to a first embodiment of the invention.

FIG. 2 is a block diagram showing a power-saving system for a computer peripheral according to a second embodiment of the invention.

FIG. 3 is a block diagram showing a power-saving system for a computer peripheral according to a third embodiment of the invention.

FIG. 4 is a block diagram showing a power-saving system for a computer peripheral according to a fourth embodiment of the invention.

FIG. 5 is a block diagram showing a power-saving system for a computer peripheral according to a fifth embodiment of the invention.

FIG. 6 is a block diagram showing a power-saving system for a computer peripheral according to a sixth embodiment of the invention.

FIG. 7 is a block diagram showing a power-saving system for a computer peripheral according to a seventh embodiment of the invention.

FIG. 8 is a block diagram showing a power-saving system for a computer peripheral according to an eighth embodiment of the invention.

### DETAILED DESCRIPTION OF THE INVENTION

First Embodiment

FIG. 1 is a block diagram showing a power-saving system for a computer peripheral according to a first embodiment of the invention. Referring to FIG. 1, the power-saving system 10 includes a computer 11, a power switch controller 12 and a computer peripheral 13. The power switch controller 12 is electrically connected to the computer 11 and the computer peripheral 13. The power switch controller is for detecting an operation mode of the computer 11, receiving a power P and transmitting the power P to the computer peripheral 13. The computer peripheral 13 receives the power P through the power switch controller 12 and communicates with the computer 11 through the power switch controller 12. When the power switch controller 12 detects that the computer 11 is in an idle mode, the power switch controller 12 cuts off the power P to the computer peripheral 13. The idle mode may be, for example, a suspense mode.

In addition, the power-saving system 10 further includes a power adaptor 14 for electrically connecting the power switch controller 12 to the computer peripheral 13. The power adaptor 14 and the power switch controller 12 are integrated into a unit, such that the power adaptor 14 and the power switch controller 12 constitute a power-saving control device 15. The power-saving control device 15 is electrically connected to the computer 11 and the computer peripheral 13. The computer peripheral 13 receives the power P through the power-saving control device 15. When the power switch controller 12 detects that the computer 11 is enabled, the power switch controller 12 turns on the power P for the computer peripheral 13.

One of ordinary skill in the art also may understand that the technology of this embodiment is not limited thereto. For example, the computer peripheral 13 may be a scanner, a printer, a fax machine or a MFP (Multi-Function Peripheral). In addition, the power adaptor 14 of this embodiment also can be omitted such that the power-saving control device 15 only includes the power switch controller 12. The power switch controller 12 still detects the operation mode of the computer 11 so as to determine whether or not the power P to the computer peripheral 13 has to be cut off.

Second Embodiment

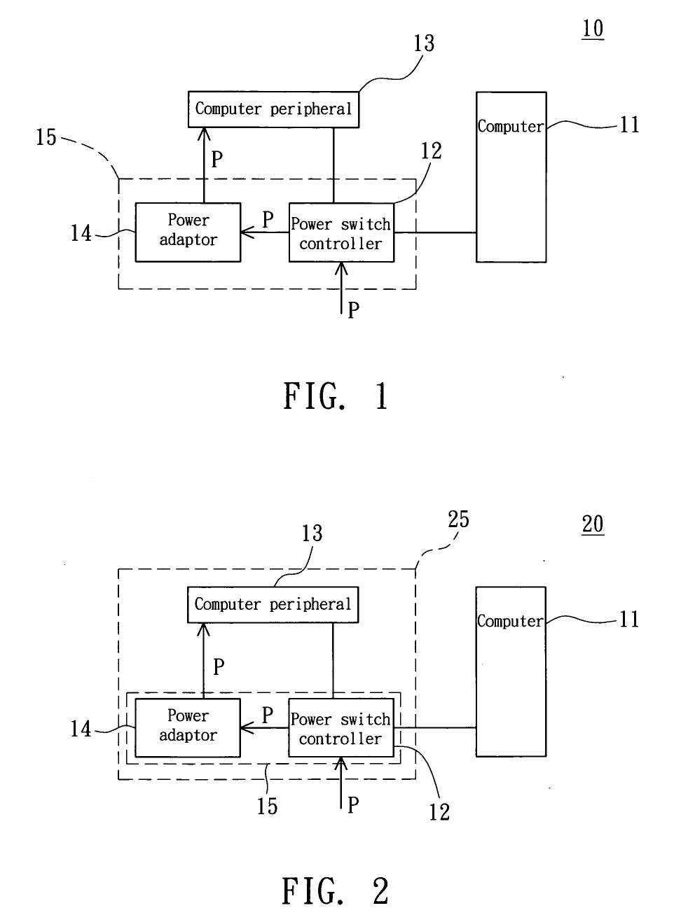

FIG. 2 is a block diagram showing a power-saving system for a computer peripheral according lo a second embodiment of the invention. As shown in FIG. 2, the power-saving system 20 differs from the power-saving system 10 of the first embodiment in that the power adaptor 14, the power switch controller 12 and the computer peripheral 13 are integrated into a unit 25 in the second embodiment. Detailed descriptions of the other components and features will be omitted because the same symbols as FIG. 1 are used in FIG. 2. In addition, the power adaptor 14 of the embodiment also can be omitted such that the power-saving control device 15 only includes the power switch controller 12. The power switch controller 12 still detects the operation mode of the computer 11 to determine whether or not the power P to the computer peripheral 13 has to be cut off.

Third Embodiment

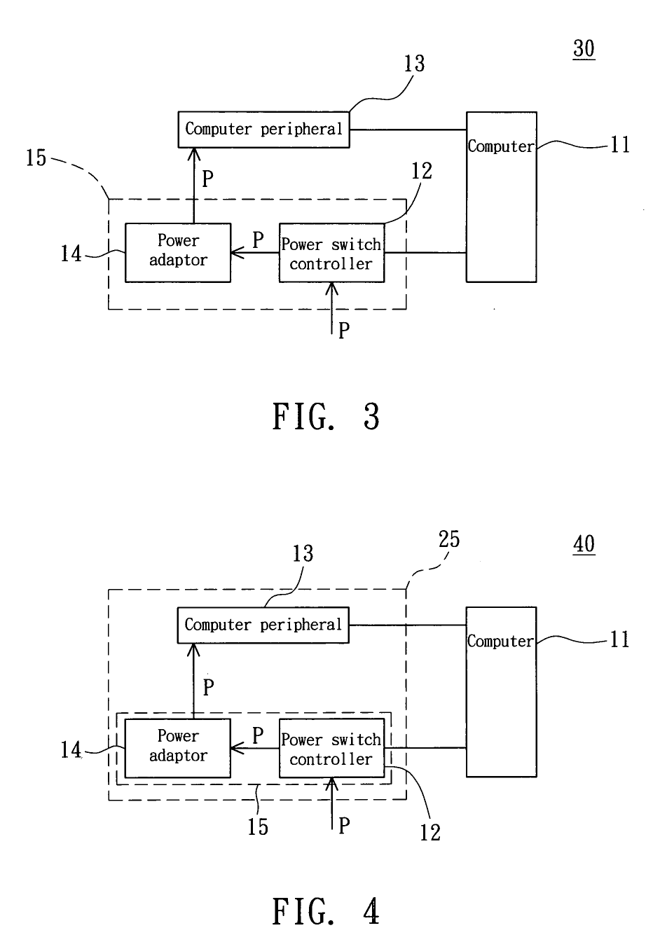

FIG. 3 is a block diagram showing a power-saving system for a computer peripheral according to a third embodiment of the invention. As shown in FIG. 3, the power-saving system 30 differs from the power-saving system 10 of the first embodiment in that the computer peripheral 13 and the power switch controller 12 individually communicate with the computer 11. In addition, the power adaptor 14 of this embodiment can be omitted such that the power-saving control device 15 only includes the power switch controller 12. The power switch controller 12 still detects the operation mode of the computer 11 so as to determine whether or not the power P to the computer peripheral 13 has to be cut off.

Fourth Embodiment

FIG. 4 is a block diagram showing a power-saving system for a computer peripheral according to a fourth embodiment of the invention. As shown in FIG. 4, the power-saving system 40 differs from the power-saving system 20 of the second embodiment in that the computer peripheral 13 and the power switch controller 12 individually communicate with the computer 11. In addition, the power adaptor 14 of the embodiment can be omitted such that the power-saving control device 15 only includes the power switch controller 12. The power switch controller 12 still detects the operation mode of the computer 11 so as to determine whether or not the power P to the computer peripheral 13 has to be cut off.

Fifth Embodiment

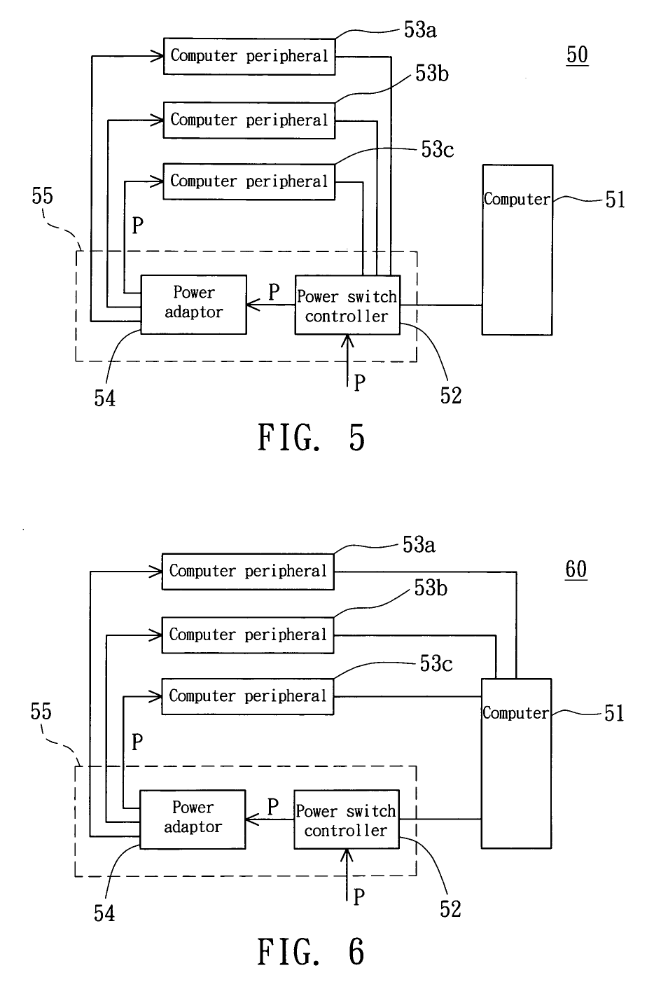

FIG. 5 is a block diagram showing a power-saving system for a computer peripheral according to a fifth embodiment of the invention. Referring to FIG. 5, the power-saving system 50 includes a computer 51, a power switch controller 52 and several computer peripherals, such as computer peripherals 53a, 53b and 53c. The power switch controller 52 is electrically connected to the computer 51 and the computer peripherals 53a to 53c. The power switch controller 52 is for detecting an operation mode of the computer 51, receiving a power P and transmitting the power P to the computer peripherals 53a to 53c. The computer peripherals 53a to 53c receive the power P through the power switch controller 52, and communicate with the computer 51 through the power switch controller 52. When the power switch controller 52 detects that the computer 51 is in an idle mode, the power switch controller 52 cuts off the power P to the computer peripherals 53a to 53c. The idle mode may be, for example, a suspense mode.

In addition, the power-saving system 50 further includes at least one power adaptor 54 for electrically connecting the power switch controller 52 to the computer peripherals 53a to 53c. Of course, three power adaptors for electrically connecting the power switch controller 52 to the computer peripherals 53a to 53c respectively also may be provided in this embodiment. The power adaptor 54 and the power switch controller 52 are integrated into a unit such that the power adaptor 54 and the power switch controller 52 constitute a power-saving control device 55. The power-saving control device 55 is electrically connected to the computer 51 and the computer peripherals 53a to 53c. The computer peripherals 53a to 53c receive the power P through the power-saving control device 55. When the power switch controller 52 detects that the computer 51 is enabled, the power switch controller 52 turns on the power P for the computer peripherals 53a to 53c.

One of ordinary skill in the art also may understand that the technology of this embodiment is not limited thereto. For example, the computer peripherals 53a to 53c may be any combination among the scanners, printers, fax machines or MFPs. In addition, the power adaptor 54 of this embodiment also can be omitted such that the power-saving control device 55 only includes the power switch controller 52. The power switch controller 52 still detects the operation mode of the computer 51 so as to determine whether or not the power P to the computer peripherals 53a to 53c has to be cut off.

Sixth Embodiment

FIG. 6 is a block diagram showing a power-saving system for a computer peripheral according to a sixth embodiment of the invention. As shown in FIG. 6, the power-saving system 60 differs from the power-saving system 50 of the fifth embodiment in that the computer peripherals 53a to 53c and the power switch controller 52 individually communicate with the computer 51. In addition, the power adaptor 54 of this embodiment may be omitted such that the power-saving control device 55 only includes the power switch controller 52. The power switch controller 52 still detects the operation mode of the computer 51 so as to determine whether or not the power P to the computer peripherals 53a to 53c has to be cut off.

Seventh Embodiment

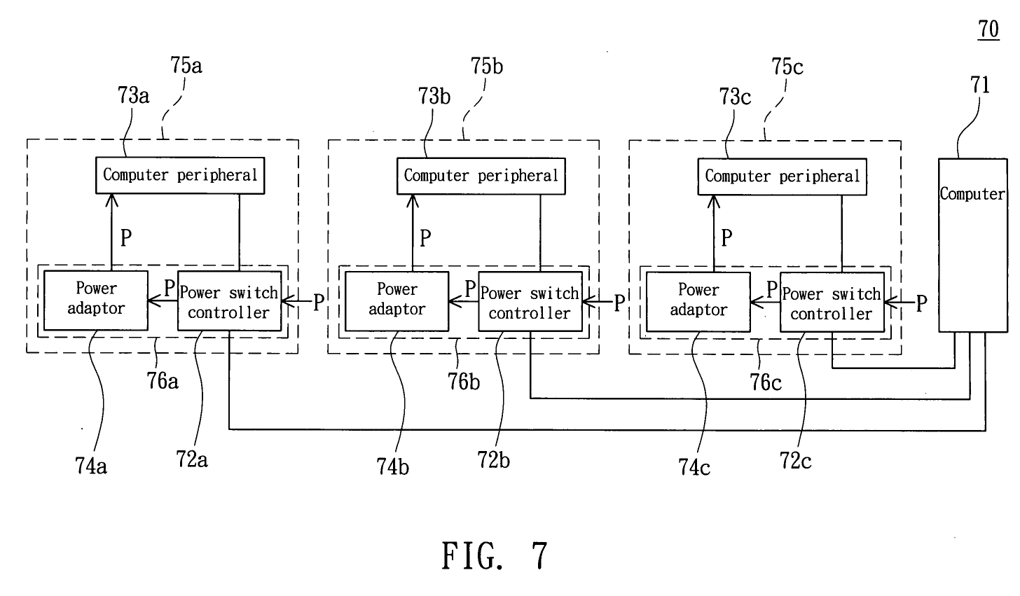

FIG. 7 is a block diagram showing a power-saving system for a computer peripheral according to a seventh embodiment of the invention. Referring to FIG. 7, the power-saving system 70 includes a computer 71 and several units, such as units 75a, 75b and 75c. The unit 75a includes a power switch controller 72a and a computer peripheral 73a. The power switch controller 72a is for detecting an operation mode of the computer 71, receiving a power P and transmitting the power P to the computer peripheral 73a. The computer peripheral 73a receives the power P through the power switch controller 72a and communicates with the computer 71 through the power switch controller 72a. When the power switch controller 72a detects that the computer 71 is in an idle mode, the power switch controller 72a cuts off the power P to the computer peripheral 73a.

The unit 75b includes a power switch controller 72b and a computer peripheral 73b. The power switch controller 72b is for detecting the operation mode of the computer 71, receiving the power P and transmitting the power P to the computer peripheral 73b. The computer peripheral 73b receives the power P through the power switch controller 72b and communicates with the computer 71 through the power switch controller 72b. When the power switch controller 72b detects that the computer 71 is in the idle mode, the power switch controller 72b cuts off the power P to the computer peripheral 73b.

The unit 75c includes a power switch controller 72c and a computer peripheral 73c. The power switch controller 72c is for detecting the operation mode of the computer 71, receiving the power P and transmitting the power P to the computer peripheral 73c. The computer peripheral 73c receives the power P through the power switch controller 72c and communicates with the computer 71 through the power switch controller 72c. When the power switch controller 72c detects that the computer 71 is in the idle mode, the power switch controller 72c cuts off the power P to the computer peripheral 73c. The idle mode may be, for example, a suspense mode.

The unit 75a further includes a power adaptor 74a for electrically connecting the power switch controller 72a to the computer peripheral 73a. The power adaptor 74a and the power switch controller 72a constitute a power-saving control device 76a, which receives the power P through the power-saving control device 76a. The unit 75b further includes a power adaptor 74b for electrically connecting the power switch controller 72b to the computer peripheral 73b. The power adaptor 74b and the power switch controller 72b constitute a power-saving control device 76b, which receives the power P through the power-saving control device 76b. The unit 75c further includes a power adaptor 74c for electrically connecting the power switch controller 72c to the computer peripheral 73c. The power adaptor 74c and the power switch controller 72c constitute a power-saving control device 76c, which receives the power P through the power-saving control device 76c.

When the power switch controllers 72a to 72c have detected that the computer 71 is enabled, the power switch controllers 72a to 72c turn on the power P for the computer peripherals 73a to 73c, respectively. One of ordinary skill in the art also may understand that the technology of this embodiment is not limited thereto. For example, the computer peripherals 73a to 73c may be any combination among the scanners, printers, fax machines or MFPs. In addition, the power adaptors 74a to 74c of this embodiment also can be omitted such that the power-saving control devices 75a to 75c correspondingly include the power switch controllers 72a to 72c. The power switch controllers 72a to 72c still detect the operation mode of the computer 71 so as to determine whether or not the power P to the corresponding computer peripherals 73a to 73c has to be cut off.

Eighth Embodiment

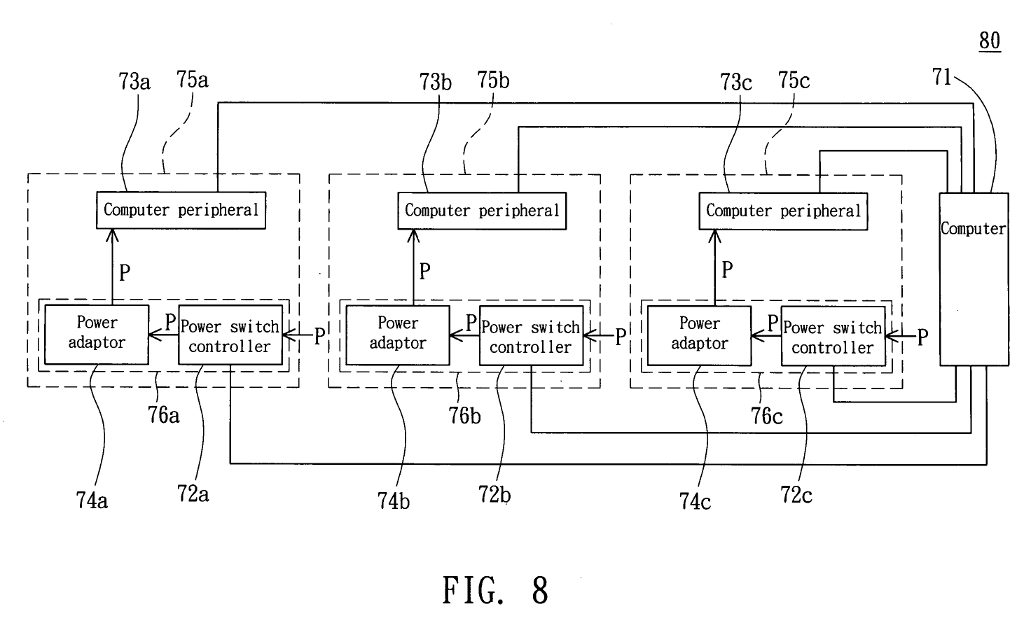

FIG. 8 is a block diagram showing a power-saving system for a computer peripheral according to an eighth embodiment of the invention. As shown in FIG. 8, the power-saving system 80 differs from the power-saving system 70 of the seventh embodiment in that the computer peripherals 73a to 73c and the power switch controllers 72a to 72c individually communicate with the computer 71. In addition, the power adaptors 74a to 74c of this embodiment may be omitted such that the power-saving control devices 75a to 75c correspondingly include the power switch controllers 72a to 72c. The power switch controllers 72a to 72c still detect the operation mode of the computer 71 so as to determine whether or not the power P to the corresponding computer peripherals 73a to 73c has to be cut off.

The power-saving systems for a computer peripheral according to the embodiments of the invention have the power switch controller capable of cutting off the power transmitted to the computer peripherals when the computer enters the idle mode. Thus, it is possible to reduce the energy usage and the electromagnetic wave intensity, and to meet the newest power-saving specification for electrical devices in the United States.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A power-saving control device to be electrically connected to a computer and a first computer peripheral, the power-saving control device comprising:
a power switch controller for detecting an operation mode of the computer, receiving a power and transmitting the power to the first computer peripheral, wherein the power switch controller cuts off the power to the first computer peripheral when the power switch controller detects that the computer is in an idle mode.

2. The power-saving control device according to claim 1, wherein the idle mode is a suspense mode.

3. The power-saving control device according to claim 1, wherein the first computer peripheral communicates with the computer through the power-saving control device.

4. The power-saving control device according to claim 1, wherein the first computer peripheral and the power-saving control device individually communicate with the computer.

5. The power-saving control device according to claim 1, wherein the power-saving control device and the first computer peripheral are integrated into a unit.

6. The power-saving control device according to claim 5, wherein the first computer peripheral device communicates with the computer through the power-saving control device.

7. The power-saving control device according to claim 5, wherein the first computer peripheral and the power-saving control device individually communicate with the computer.

8. The power-saving control device according to claim 1, further comprising:
a power adaptor for electrically connecting the power switch controller to the first computer peripheral.

9. The power-saving control device according to claim 1, wherein the power-saving control device is electrically connected to a plurality of second computer peripherals, which receive the power through the power-saving control device and communicate with the computer, and when the power switch controller detects that the computer is in the idle mode, the power switch controller cuts off the power to the second computer peripherals.

10. A power-saving system comprising:
a computer and a first computer peripheral; and
a power switch controller, electrically connected to the computer and the first computer peripheral, for detecting an operation mode of the computer, receiving a power, and transmitting the power to the first computer peripheral, wherein the power switch controller cuts off the power to the first computer peripheral when the power switch controller detects that the computer is in an idle mode.

11. The power-saving system according to claim 10, wherein the first computer peripheral communicates with the computer through the power switch controller.

12. The power-saving system according to claim 10, wherein the first computer peripheral and the power switch controller individually communicate with the computer.

13. The power-saving system according to claim 10, wherein the first computer peripheral and the power switch controller are integrated into a unit.

14. The power-saving system according to claim 10, wherein the idle mode is a suspense mode.

15. The power-saving system according to claim 10, further comprising:
a power adaptor for electrically connecting the power switch controller to the first computer peripheral.

16. The power-saving system according to claim 15, wherein the power adaptor and the power switch controller are integrated into a unit.

17. The power-saving system according to claim 15, wherein the power adaptor, the first computer peripheral and the power switch controller are integrated into a unit.

18. The power-saving system according to claim 10, further comprising:
a plurality of second computer peripherals for receiving the power through the power switch controller and communicating with the computer, wherein when the power switch controller detects that the computer is in the idle mode, the power switch controller cuts off the power to the second computer peripherals.
